(19) United States
(12) Patent Application Publication
(10) Pub. No.: US 2023/0146736 A1
(43) Pub. Date: May 11, 2023

(54) DATA PATH MANAGEMENT SYSTEM AND METHOD FOR WORKSPACES IN A HETEROGENEOUS WORKSPACE ENVIRONMENT

(71) Applicant: Dell Products, L.P., Round Rock, TX (US)

(72) Inventors: Gokul Thiruchengode Vajravel, Bangalore (IN); Vivek Viswanathan Iyer, Austin, TX (US)

(73) Assignee: Dell Products, L.P., Round Rock, TX (US)

(21) Appl. No.: 17/522,513

(22) Filed: Nov. 9, 2021

(51) Int. Cl. G06F 8/65; G06F 8/71; H04L 67/00; H04L 67/10

(52) U.S. Cl. CPC G06F 8/65; G06F 8/71; H04L 67/34; H04L 67/10

(57) ABSTRACT

Systems and methods for deploying software updates in heterogeneous workspace environments are described. The system for managing workspaces includes computer-executable instructions for obtaining multiple inventories corresponding to multiple workspaces of an IHS, wherein the inventories each include information associated with the applications deployed in its respective workspace. The instructions are further executed to, for each inventory, identify the workspace associated with the inventory, determine which of the applications are to be updated with new software, and deploy the determined new software to the identified workspace.

### FIELD

This disclosure relates generally to Information Handling Systems (IHSs), and, more specifically, to a data path management system and method for workspaces in a heterogeneous workspace environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

IHSs provide users with capabilities for accessing, creating, and manipulating data. IHSs often implement a variety of security protocols in order to protect this data during such operations. A known technique for securing access to protected data that is accessed via an IHS is to segregate the protected data within an isolated software environment that operates on the IHS, where such isolated software environments may be referred to by various names, such as virtual machines, containers, dockers, etc. Various types of such segregated environments are isolated by providing varying degrees of abstraction from the underlying hardware and from the operating system of the IHS. These virtualized environments typically allow a user to access only data and applications that have been approved for use within that particular isolated environment. In enforcing the isolation of a virtualized environment, applications that operate within such isolated environments may have limited access to capabilities that are supported by the hardware and operating system of the IHS.

### SUMMARY

Systems and methods for deploying software updates in heterogeneous workspace environments are described. According to one embodiment, the system for managing workspaces includes computer-executable instructions for obtaining multiple inventories corresponding to multiple workspaces of an IHS, wherein the inventories each include information associated with the applications deployed in its respective workspace. The instructions are further executed to, for each inventory, identify the workspace associated with the inventory, determine which of the applications are to be updated with new software, and deploy the determined new software to the identified workspace.

According to another embodiment, a method includes the steps of obtaining multiple inventories corresponding to multiple workspaces that are each deployed with one or more apps, and for each inventory, identifying the workspace associated with the inventory, determining which of the applications are to be updated with new software, and deploying the determined new software to the identified workspace.

According to yet another embodiment, a workspace orchestrator includes computer-executable instructions to obtain multiple inventories corresponding to multiple workspaces that are each deployed with one or more apps. The instructions then for each inventory, identify the workspace associated with the inventory, determine which of the applications are to be updated with new software, and deploy the determined new software to the identified workspace.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a diagram depicting components of an example IHS configured to implement systems and methods for managing workspaces in a heterogeneous workspace environment.

FIG. 2 is a diagram of an example data path management system according to one embodiment of the present disclosure.

FIG. 3 illustrates several types of data paths that may be established between the workspaces of an IHS.

FIGS. 4A and 4B illustrate an example flow diagram depicting a data path management method that may be performed to establish cross workspace data paths for communicating with one another according to one embodiment of the present disclosure.

FIG. 5 illustrates an example data path updating method that may be performed to update the data paths between two linked workspaces according to one embodiment of the present disclosure.

FIGS. 6 and 7 illustrate example methods that may be performed for establishing a bridged data path between two workspaces according to one embodiment of the present disclosure.

FIGS. 8A and 8B illustrate an example workspace structure, and graphs of two example consumer apps that may be implemented by the data path management system according to one embodiment of the present disclosure.

FIG. 9 illustrates an example contextual path optimizing method that may be performed to optimize the data paths of an application and its services implemented in a heterogeneous workspace environment.

### DETAILED DESCRIPTION

Embodiments of the present disclosure provide a system and method for managing data paths between workspaces in a heterogeneous workspace environment. Whereas the type of data paths configured between workspaces has heretofore been statically assigned, no provision has been made to optimize how communication between consumer processes configured in one workspace and one or more provider processes used by the consumer processes is conducted. Embodiments of the present disclosure provide a solution to this problem, among others, using a system that detects when such scenarios exist, and identifying a data path that optimally meets the requirements of the consumer processes and their associated provider processes.

Currently implemented IHSs used by consumers are configured with workspaces, such as software-based workspaces (e.g., docker), hardware-based workspaces (e.g., virtualBox, VMWare, etc.), and cloud-based workspaces. To meet this demand, many computing devices (e.g., IHSs) are now being provided with workspace orchestrators that manage how the workspaces are used in the IHS. Such workspace orchestrators involve the concepts of orchestration, optimization of the IHS, and composition for OS and SOC agnostic UI/UX for modern clients, while preserving key parts of the traditional client experience (e.g., do-no-harm). The workspace orchestrator provides workload orchestration with concurrent workspaces of varying performance and security levels running on the IHS as well as in the cloud. The workspaces are implemented using container technologies.

For these workspace orchestrators, most or all applications, with the exception of certain low level OS or vendor services, are run inside of a workspace for better security and scalability reasons. The workspaces can be implemented using software isolation techniques, such as Docker, Snap, and the like or using hardware isolation methods like Hyper-V docker, lightweight VMs (e.g., Photon-OS, IncludeOS, etc.) and full bare-metal-based VMs. A workspace generally refers to an isolated environment that can host one or more applications. A workspace host refers to software based (e.g., Docker) or hypervisor/hardware based (e.g., Kata container, VM, etc.) solutions to provide the isolated environments for the workspace orchestrator.

With introduction of workspaces, the apps (consumer) and the services (providers) are put in individual workspaces for better manageability, scalability, and security reasons. Unlike cloud workspaces (e.g., Azure Containers, AWS ECS, etc.), the IHS based workspace solutions offer different types of isolation. For example, Sandboxie provides namespace-level isolation, Docker/SW-containers can provide more complete OS resource isolation, while Kata workspaces or VMs (e.g., Hypervisor/VM based) can provide up to bare metal level of isolation. Moreover, each of these workspace vendors/types supports a subset of different data paths for inter communication.

Nevertheless, when these consumer apps and their dependent provider services are deployed in different workspace types, the following challenges are faced. For one, the app and the dependent service do not know about their workspace host info and/or their communicating capabilities. Another challenge is that each data path type has different properties (e.g., bandwidth, Max-PDU, latency, etc.), so it would be beneficial to select a data path that provides for optimal communication between the consumer app and its dependent services. As will be described in detail herein below, embodiments of the present disclosure provide solutions to these problems, among others, by implementing a system and method for managing data paths for workspaces in a heterogeneous workspace environment.

Many currently available IHSs also referred to as computing devices are configured with heterogeneous workspaces for various reasons including enhanced isolation of apps, security improvements, and the like. Example workspaces may include software-based workspaces (e.g., docker, snap, Progressive Web App (PWA), Virtual Desktop Integration (VDI), etc.), hardware-based workspaces (e.g., Virtual Machines (VMs)), or cloud-based workspaces that are accessed from a publicly available communication network, such as the Internet. These workspaces are typically managed using orchestrators that can manage software-based workspaces, hardware-based workspaces, as well as cloud-based workspaces. Workspaces may have varying levels of performance and security KPIs running in the IHS as well as in the cloud.

It would often be useful to, with the exception of certain Operating System and vendor service apps, encapsulate most applications in a workspace for enhanced security and scalability purposes. The workspaces can be implemented using software or hardware isolation methods. With hardware isolation methods, a guest OS can be different from the host OS, thus creating a heterogeneous computing environment. For example, a Windows10 host OS may use a lightweight Ubuntu guest OS to run Linux-native applications and/or certain web-apps.

With the widespread introduction of orchestrators, the Information Technology Decision Maker (ITDM) may need to adopt management of heterogeneous workspaces (e.g., clients) involving a mix of cloud native apps, containerized native “workspace” apps, and local (e.g., endpoint) native services (e.g., apps, drivers, etc.) that are executed directly by the host OS. For example, an IHS deployed with a Windows10 host OS can have an Electron based App and a Windows 32-bit native application running locally, a Web-application or UWP application running inside a software-based workspace (e.g., Sandboxie), and Ubuntu applications running inside a hardware-based workspace. The problem is that conventional management tools (e.g., orchestrators) do not typically support such a heterogeneous computing environment and/or the various use cases (Infra/Inter-HS orchestration) that it may encounter.

To provide a particular use-case example, the ITDM often encounters challenges with updating software on workspaces, particularly when certain applications executed on different workspaces may possess dependencies to one another.

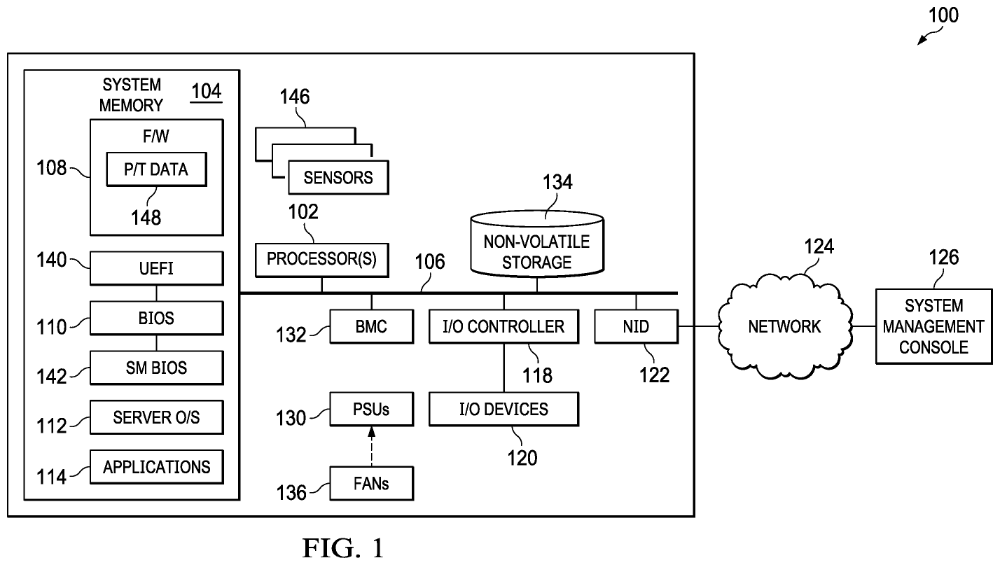

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. FIG. 1 shows various internal components of an IHS configured to implement certain of the described embodiments. It should be appreciated that although certain embodiments described herein may be discussed in the context of a personal computing device, other embodiments may utilize various other types of IHSs.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, science, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price.

Embodiments described herein comprise systems and methods for high granularity control of power and/or thermal characteristics of an Information Handling System (IHS). The system and method uses a baseboard management controller (BMC) configured on the IHS to obtain power profile data as well as thermal profile data for the hardware devices configured in the IHS, and, based on this data, optimally control the power and thermal system of the IHS. For some or most of the hardware devices, the power profile data and thermal profile data is obtained from the system Basic Input/Output System (BIOS). For other cases, the power profile data and thermal profile data is obtained from user input and validated to ensure its validity against one or more parameters. In some embodiments, a trial and error thermal profile acquisition technique may be employed to empirically determine a thermal profile for a hardware device, such as one that is not registered in the system BIOS.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

FIG. 1 is a block diagram of examples of components of an Information Handling System (IHS), according to some embodiments. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of IHS 100. This feature can eliminate the need for the operating system to probe hardware directly to discover what devices are present in the computer.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI) may be coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, PSUs 130, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (iDRAC)). In other embodiments, BMC 132 may include or may be an integral part of a Chassis Management Controller (CMC).

In many cases, the hardware devices configured on a typical IHS 100 are registered in its system BIOS. In such cases, BIOS 110 may be accessed to obtain the power/thermal profile data table 148 for those hardware devices registered in BIOS 110. For any non-registered (unsupported/unqualified) hardware device, however, its power profile and/or thermal profile may be unknown. In such situations, the server thermal control is often required to run in an open loop. That is, the thermal profile for the IHS 100 may be difficult, if not impossible, to optimize.

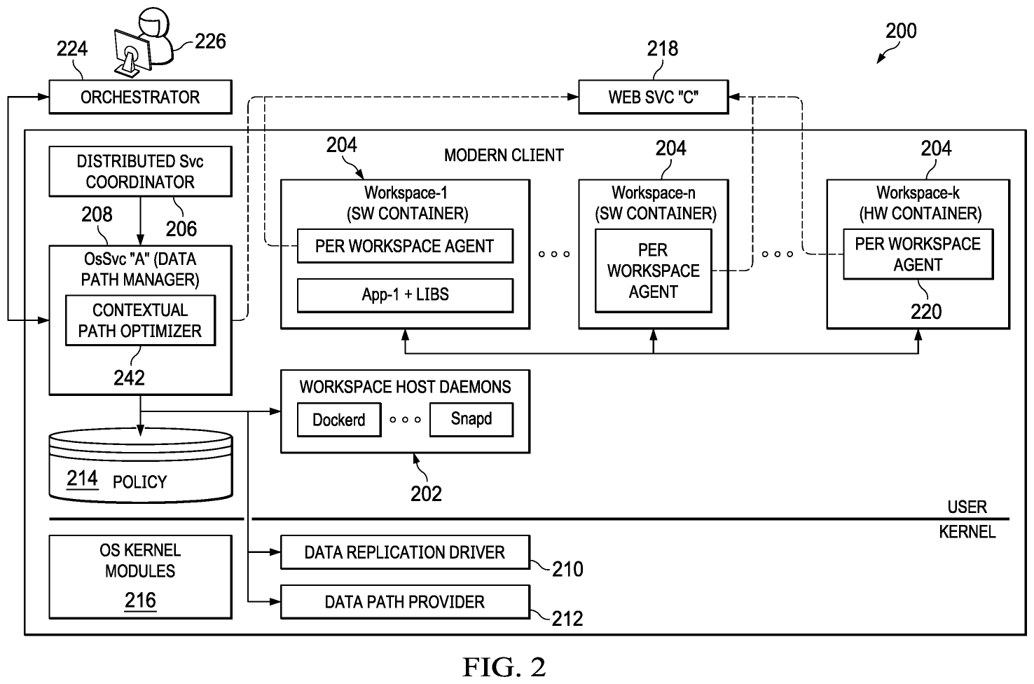

FIG. 2 is a diagram of an example of a data path management system 200 according to one embodiment of the present disclosure. The system 200 includes one or more workspace host daemons 202 (e.g., Dockerd, Snapd, etc.) that each generates workspaces 204 to be used by IHS 100. The workspace host daemon 202 may be a type-1, native, or bare-metal hypervisor running directly on IHS 100, or it may include a type-2 or hosted hypervisor running on top of the host OS of the IHS 100. For example workspace 204-1, 204-n are software-based workspaces (e.g., (e.g., docker, snap, Progressive Web App (PWA), INTEL Clear Container, etc.), while workspace 204-k is a hardware-based workspace (e.g., VMWare, VirtualBox, etc.).

The system 200 includes a data path manager 208 that runs on the host OS of the IHS 100. The data path manager 208 is controlled by the distributed services coordinator 206 and orchestrator 224, and communicates with the workspace host daemons 202, data replication driver 210, and data path providers 212 using data path management policies 214. The data path providers 212 may use certain services provided by one or more Kernel modules 216. In one embodiment, the data path manager 208 may also be configured with a contextual path optimizer 242 that continually monitors the data paths between the workspaces 204 and optimizes those data paths according to how they are contextually driven. Web service 218 is provided for enabling communication with each workspace agent 220.

In some embodiments, when applications are distributed and/or deployed from a trusted source, software-based workspaces 204-1, 204-n may be used as it generally has less overhead and provides higher containerized application density. Conversely, when applications are distributed and/or deployed from an untrusted source, hardware-based and/or hypervisor-isolated hardware workspace 204-k may be used, despite presenting a higher overhead, to the extent it provides better isolation or security.

Software workspaces 204-1, 204-n may share the kernel of host OS and UEFI services, but access is restricted based upon the user's privileges. Hardware workspace 204-k has a separate instance of OS and UEFI services. In both cases, workspaces 204 serve to isolate applications from the host OS and other applications.

Currently implemented IHSs used by consumers are configured with workspaces, such as software-based workspaces (e.g., docker), hardware-based workspaces (e.g., virtualBox, VMWare, etc.), and cloud-based workspaces. To meet this demand, many computing devices (e.g., IHSs) are now being provided with workspace host daemons 202 (e.g., orchestrators) that manage how the workspaces are used in the IHS. Such workspace host daemons 202 involve the concepts of orchestration, optimization of the IHS, and composition for OS and SOC agnostic UI/UX for modern clients, while preserving key parts of the traditional client experience (e.g., do-no-harm). The workspace orchestrator provides workload orchestration with concurrent workspaces of varying performance and security levels running on the IHS as well as in the cloud. The workspaces are implemented using container technologies.

For these workspace host daemons 202, most or all applications, with the exception of certain low level OS or vendor services, are run inside of a workspace for better security and scalability reasons. The workspaces can be implemented using software isolation methods like docker, Snap, . . . . Or using hardware isolation methods like Hyper-V docker, lightweight VM (e.g., Photon-OS, IncludeOS, etc.). A workspace generally refers to an isolated environment that can host one or more applications. A workspace host refers to a software based (e.g., Docker) or hypervisor/hardware based (e.g., Kata container, VM, etc.) solution to provide the isolated environments for the workspace orchestrator.

With introduction of workspaces, the apps (consumer) and the services (providers) are put in individual workspaces for better manageability, scalability, and security reasons. Unlike cloud workspaces (e.g., Azure Containers, AWS ECS, etc.), the IHS based workspace solutions offer different types of isolation. For example, Sandboxie provides namespace-level isolation, Docker/SW-containers can provide more complete OS resource isolation, while Kata workspaces or VMs (e.g., Hypervisor/VMM based) can provide up to bare metal level of isolation. Moreover, each of these workspace vendors/types supports a subset of different data paths for inter communication. In one embodiment, a data replication driver 210 may be used for replicating actions on one workspace 204 to another workspace 204. Additionally details of the data replication drivers will be described in detail herein below.

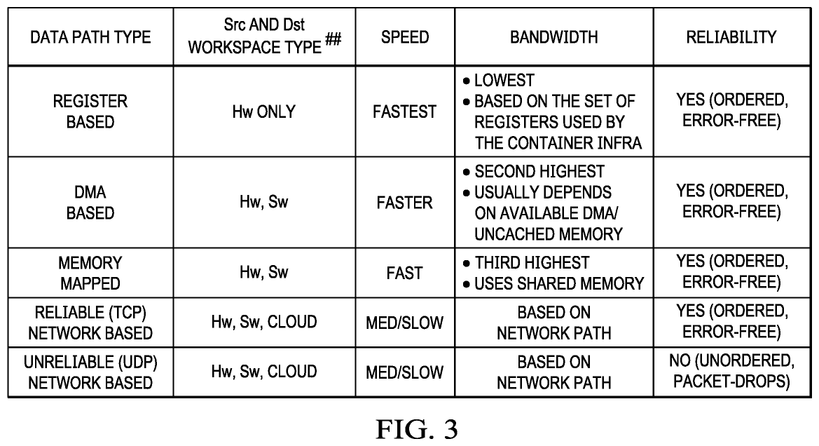

FIG. 3 illustrates several types of data paths that may be established between the workspaces 204 of an IHS 100. In particular, a register based data path provides one or more registers that can be written to the transmitting end and read from at the receiving end. While it is fast, its bandwidth is also limited by the numbers of registers established for buffering data between the transmitting and received end. A Direct Memory Access (DMA) based data path, although not quite as fast as register based data paths, it is relatively fast. The bandwidth depends upon the amount of memory allocated for its use. Additionally, only certain workspace host daemons 202 provide such a data path type for its workspaces to use. A memory mapped data path type generally refers to one in which a portion of the memory map of the host OS is dedicated for use as a communication buffer. A TCP network based data path type generally refers to one using TCP controls over Ethernet cabling to provide communication, while a UDP network based data path type uses UDP controls over Ethernet cabling to provide communication.

Nevertheless, when these consumer apps and their dependent provider services are deployed in different workspace types, the following challenges are faced. For one, the app and the dependent service do not know about their workspace host info and/or their communicating capabilities. For another reason, each data path type has different properties (e.g., bandwidth, Max-PDU, latency, etc.), so it would be beneficial to select a data path that provides for optimal communication between the consumer app and its dependent services. As will be described in detail herein below, embodiments of the present disclosure provide solutions to these problems, among others, by implementing a system and method for managing data paths for workspaces in a heterogeneous workspace environment.

Many currently available IHSs also referred to as computing devices are configured with heterogeneous workspaces for various reasons including enhanced isolation of apps, security improvements, and the like. Example workspaces may include software-based workspaces (e.g., docker, snap, Progressive Web App (PWA), Virtual Desktop Integration (VDI), etc.), hardware-based workspaces (e.g., Virtual Machines (VMs)), or cloud-based workspaces that are accessed from a publicly available communication network, such as the Internet. These workspaces are typically managed using orchestrators that can manage software-based workspaces, hardware-based workspaces, as well as cloud-based workspaces. Workspaces may have varying levels of performance and security KPIs running in the IHS as well as in the cloud.

It would often be useful to, with the exception of certain Operating System and vendor service apps, encapsulate most applications in a workspace for enhanced security and scalability purposes. The workspaces can be implemented using software or hardware isolation methods. With hardware isolation methods, a guest OS can be different from the host OS, thus creating a heterogeneous computing environment. For example, a Windows10 host OS may use a lightweight Ubuntu guest OS to run Linux-native applications and/or certain web-apps.

With the widespread introduction of orchestrators, the Information Technology Decision Maker (ITDM) may need to adopt management of heterogeneous workspaces (e.g., clients) involving a mix of cloud native apps, containerized native “workspace” apps, and local (e.g., endpoint) native services (e.g., apps, drivers, etc.) that are executed directly by the host OS. For example, an IHS deployed with a Windows10 host OS can have an Electron based App and a Windows 32-bit native application running locally, a Web-application or UWP application running inside a software-based workspace (e.g., Sandboxie), and Ubuntu applications running inside a hardware-based workspace. The problem is that conventional management tools (e.g., orchestrators) do not typically support such a heterogeneous computing environment and/or the various use cases (Infra/Inter-HS orchestration) that it may encounter.

To provide a particular use-case example, the ITDM often encounters challenges with updating software on workspaces, particularly when certain applications executed on different workspaces may possess dependencies to one another.

To provide a solution to data-path discovery, compatibility, and bridging issues, the system 200 may use certain components. For example, the system 200 may use a web service block 218 communications port routing Inter-Process Communication (IPC) between services, to keep fundamental security/isolation paradigms of containers intact while managing the secure communications through manageability/orchestration back-end services. The system 200 may also use a per workspace agent 220 running inside each workspace that functions along with data path manager 208 by providing the bundled apps information (e.g., app name, manifest file, app-state, peripherals used, CPU/RAM/GPU . . . resources used, consumption info, etc.). The per workspace agent 220 provides an API export/import based on the workspace payload. The data path manager 208 running on the host, outside of the workspaces 204, essentially functions as a cross workspace data-path manager.

It does the following, on initialization, it connects with the ITDM console 226, and downloads the config file that has app information, their dependencies and the workspace host information (e.g., [Adobe Creative; SSO-Svc, GPU-Lib-Svc; Intel Clear Container], [SSO-Svc; none; software-docker], [GPU-Lib-Svc; none; Snap-Container], etc.). This information is cached as Table-1. It should be important to note that Table-1 is meant to be exhaustive, rather it is only intended to show several example workspaces and corresponding apps that may be configured on those workspaces.

TABLE 1

| Containerized App | App type | Dependencies | Container type |
|---|---|---|---|
| Adobe | Consumer | GPU-Lib, | Intel Clear Container |
| Creative | | SSO-Svc | |
| GPU-Libs | Provider | <None> | SW-Docker container |
| SSO-Svc | Provider | <None> | Snap Container |

The data path manager 208 works with the respective vendor workspace daemons 202 to identify any spawned workspaces that may have occurred since the last time the workspaces 204 had been discovered. Additionally, the data path manager 208 establishes sessions with each per workspace agent 220 running inside every workspace. The data path manager 208 also identifies the workspace's data-path capabilities and the interfaces/API of its data-path providers shown below in Table-2. It should be appreciated that Table-2 is not meant to be exhaustive, rather it is only intended to show several example workspace types and the data path types supported by those workspaces.

TABLE 2

| Workspace Type | Vendor | Supported Data paths |
|---|---|---|
| Intel Clear | Intel | Register based, |
| Container | | IOMMU DMA based, |
| | | Memory mapped based & |
| | | Network based |
| SW-Docker | Docker | IOMMU DMA based, |
| container | | Memory mapped based & |
| | | Network based |
| Snap Container | Canonical | Snap Interfaces & |
| | | Network based |

Using Table-1, the data path manager 208 identifies any consumer Apps and their dependent provider services to be linked via a data-path. Whenever the distributed service coordinator 206 wants to establish a data path session across workspaces, the data path manager 208 may access, for example, Table-2 to identify any common supported data-path and establishes the cross workspace data-path between the consumer and its provider. In static conditions, if any inter or intra IHS workspace migration is initiated, the distributed service coordinator 206 shall provide the respective notifications. On pre-migrate notification, the data path manager 208 may query the distributed service coordinator 206, and retrieve the respective app's new workspace information, such as workspace type, vendor-information, data-path capabilities, daemon-info, and location (cloud/IHS). In this step, Tables 1 and 2 may be updated accordingly.

During actual migration, the data path manager 208 may purge the outdated data-paths (made with the older workspace-host) and shall create the new data-paths based on the updated Table-2. In one embodiment, the existing workspace migration feature takes care of pausing and resuming the data-flow during the (online) migration. If, however, there are no common data-path types between two workspaces or any available data paths are restricted due to the security/admin configuration, the data path manager 208 establishes a bridge data-path between those two. For example, the data path manager 208 establishes a data path-1 (e.g., IOMMU DMA) with a consumer app on a first workspace 204, and a second data path-2 (e.g., memory map based data path) with a provider app on a different workspace 204. The data path manager 208 then retrieves any resulting payload (e.g., API request, data, response, etc.), buffers it and packs the payload as per data-path-2 requirements (e.g., memory-map based data path). The data path manager 208 then sends the payload to the provider workspace via Data-path-2.

In one embodiment, the per workspace agent 220 may provide and export the data-path's telemetry info (e.g., bytes transferred, speed, latency, error-rate, average payload size, retry-count, etc.) to the data path manager 208. The data path manager 208 may then collate and provide more insights, such as per-cross-workspace data-path telemetry, per-data-path-type telemetry, etc.).

For replication and snooping purposes, the data-replication driver 210 may perform buffering and replicate the data across same/different transport to an authorized workspace. For example, the data path manager 208 hosting a pulse-audio (e.g., Mic input audio stream) provider in a first workspace 204 is linked with a second workspace 204 hosting a Zoom.exe consumer app. Additionally, a third workspace 204 hosting a speech-to-text engine may transparently latch and consume the audio-stream for speech-to-text conversion. In addition to data replication, this embodiment may be used for transport debugging and profiling purposes. In such a mode, data replication driver 210 may capture the responses of the second workspace 204 hosting the Zoom.exe application, and send it to the third workspace 204 for snooping and/or debugging support. In one embodiment, the new transparent workspace linking order may be logged in the IT Config file explicitly (e.g., Speech-To-Text.exe; pulse-audio-Svc, Zoome.exe; Intel Clear Container).

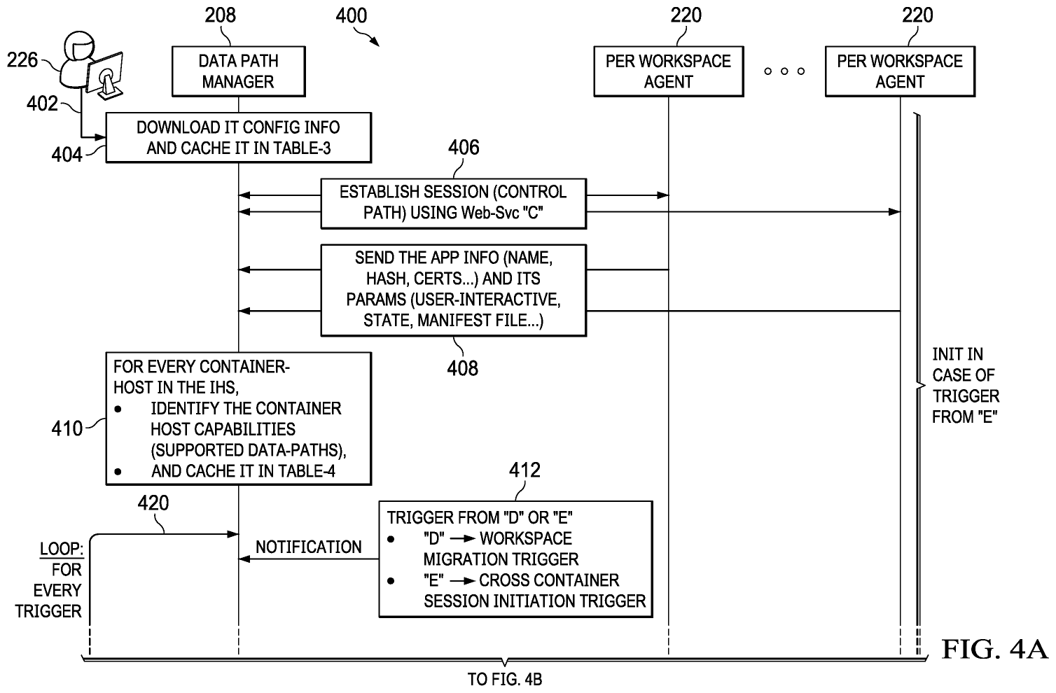

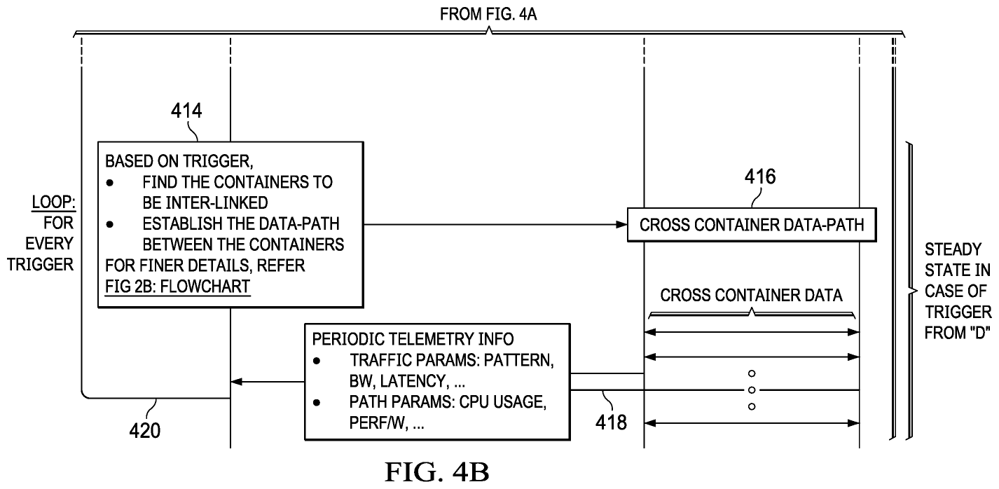

FIG. 4 illustrates an example flow diagram depicting a data path management method 400 that may be performed to establish cross workspace data paths for communicating with one another according to one embodiment of the present disclosure. In one embodiment, some, most, or all steps described herein may be performed by the data path management system 200 as described above with reference to FIG. 2.

Initially at step 402, the data path manager 208 receives an IT configuration including apps, dependencies, and their workspace information, from the ITDM management console 226. Thereafter at step 404, the data path manager 208 downloads and caches the received information. For example, the cached information may look somewhat like the information described in Table-1 above.

At step 406, the data path manager 208 establishes a Web based communication session with each of two per workspace agents 220 configured on workspaces 204 that are to be established with a data path link. For example, the data path manager 208 may establish a communication session with each of the per workspace agents 220 via the web service 218. Once the connection is established, each of the per workspace agents 220 sends its app information, such as a name of the app, hash value of the executable file, certifications, app state, manifest file, and the like at step 408.

At step 410, the data path manager 208 identifies the workspace capabilities (e.g., supported data paths), and caches the identified information for every workspace 204 in the IHS 100. For example, the information cached by the data path manager 208 may look somewhat similar to the information shown in Table-2 described above.

A trigger may be received from either the ITDM management console 226 or the distributed service coordinator 206. For example, receipt of a trigger from the ITDM management console 226 typically means that a workspace migration trigger has been manually inputted, while receipt of the trigger from the distributed service coordinator 206 typically means that some form of detected input has triggered the need for migration from one workspace to another workspace.

At step 414, the data path manager 208 identifies the workspaces 204 to be inter-linked, and establishes the data path between the workspaces 204. Inter-linked data path 416 is shown communicatively coupling the first workspace 204 with the second workspace 204. At this point, the data path 416 continually conveys information between the first workspace 204 and the second workspace 204. Additionally, the per workspace agent 220 in each workspace 204 may gather telemetry data associated with the health of the data path 414, and periodically report the data to the data path manager 208 at step 418. If the data path manager 208 determines that the telemetry data exhibits an excessively weak data path 416, it may re-initiate a migration to yet another type of data path 416 between the first and second workspaces 204 at step 420.

As shown, the aforedescribed method 400 may be continually performed for optimizing the data path 416 established between two workspaces 204. Nevertheless, when use of the method 400 is no longer needed or desired, the method 400 ends.

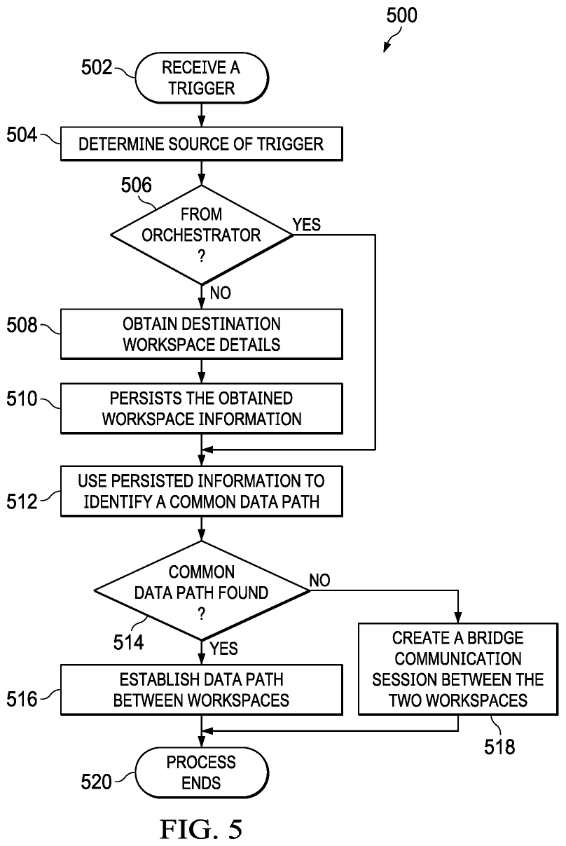

FIG. 5 illustrates an example data path updating method 500 that may be performed to update the data paths between two linked workspaces according to one embodiment of the present disclosure. In general, the updating method 500 may either be triggered by the orchestrator 224 when a migration sequence is initiated, or triggered by the distributed service coordinator 206 when it determines a need exists to update the parameters of an existing data path. In one embodiment, some, most, or all steps described herein may be performed by the data path management system 200 as described above with reference to FIG. 2.

Initially at step 502, the method 500 receives a trigger. Thereafter at step 504, the method 500 determines a source of the trigger. In particular, the method 500 determines at step 506, whether the trigger originated from the orchestrator 224 or the distributed service coordinator 206. If the trigger originated from the orchestrator 224, processing continues at step 512; otherwise the trigger originated from the distributed service coordinator 206 and thus, processing continues at step 508.

At step 508, the method 500 obtains the destination workspace information details, such as workspace type, vendor, supported data paths, and the like. Thereafter at step 510, the method 500 persists the obtained workspace information details. For example, the persisted data path information may look at least somewhat like the data path information shown in the Table of FIG. 3.

Step 512 is performed following step 506, or step 510. If step 512 is performed following step 506, the method 500 will use the previously persisted data path information because migration is not slated to occur. However, if step 512 is performed following step 510, the method 500 may use the newly persisted data path information because migration between workspaces is slated to occur. At step 512, the method 500 uses the persisted data path information to find a common data path type. If a common data path is found at step 514, processing continues at step 516 in which a data path is established between the two workspaces using the common data path in which the method ends at step 520. However, if no common data path type is found, the method 500 may enable a bridged session to be established between the two workspaces at step 518. Additional details of how a bridged session may be setup will be described in detail herein below. When either of step 518 or step 516 have been performed, the method 500 ends.

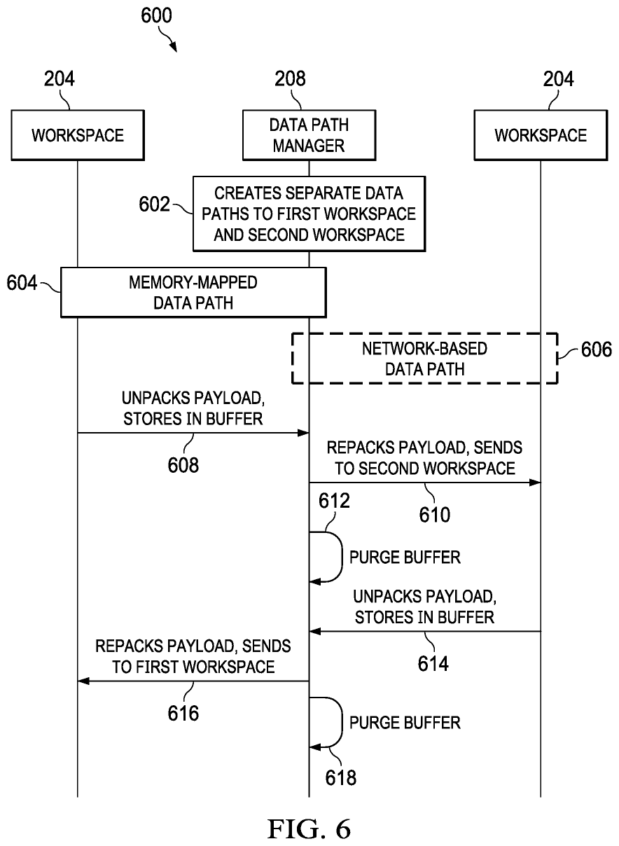

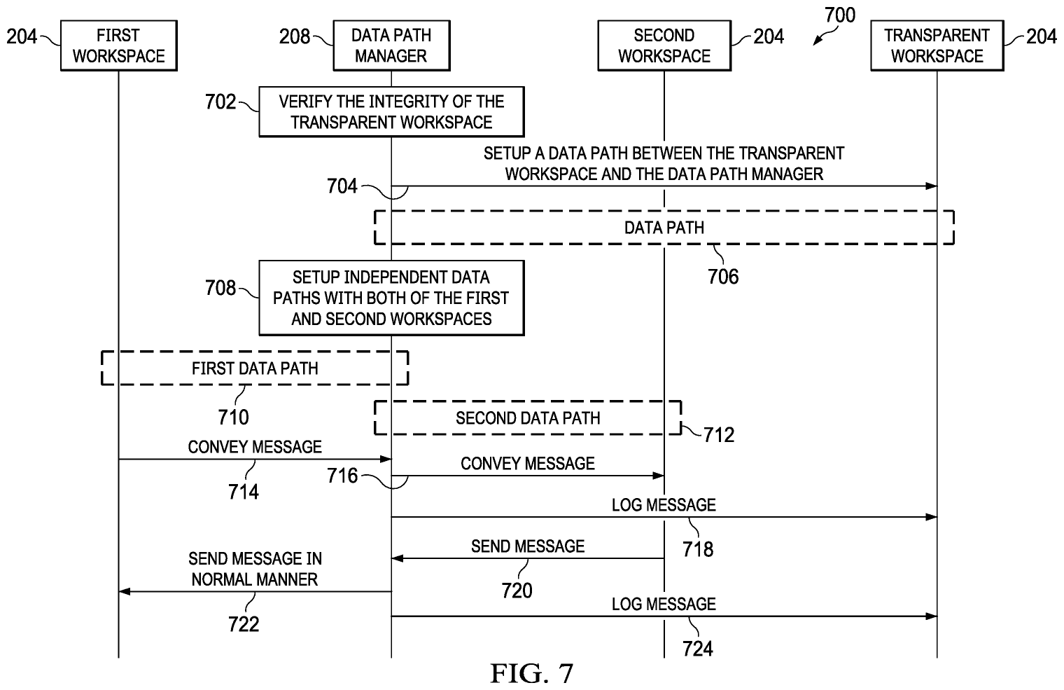

FIGS. 6 and 7 illustrates example methods 600, 700 that may be performed for establishing a bridged data path between two workspaces according to one embodiment of the present disclosure. In particular, FIG. 6 illustrates how a generic bridged data path may be established, and FIG. 7 illustrates how another bridged data path may be established using a transparent workspace, such as for monitoring, debugging, and/or profiling purposes. In certain embodiments, some, most, or all steps described in FIGS. 6 and 7 may be performed by the data path management system 200 as described above with reference to FIG. 2.

The method 600 of FIG. 6 may be performed at any suitable time. In one embodiment, the method 600 may be performed when no common data path between a first provider workspace and a second consumer workspace is found. Initially at step 602, the method 600 creates separate data paths between the data path manager 208 and each of the two workspaces 204. For example, data path 604 is a memory-mapped data path established between the first workspace 204 and the data path manager 208, while data path 606 is a network-based data path established between the second workspace 204 and the data path manager 208. Although the present embodiment is described with a first data path being a memory-mapped data path, and the second data path being a network-based data path, it should be understood that other types of data paths (DMA-based data paths, Register-based data paths, etc.) may be used without departing from the spirit and scope of the present disclosure.

When the data path manager 208 receives communications from the first workspace 204, it unpacks the payload from its initial formatting (e.g., in this case memory-mapped formatting), and stores the payload in a buffer at step 608. Moreover at step 610, the data path manager 208 repacks the payload into type-B formatting (e.g., network-based) and sends it to the second workspace 204. At step 612, the data path manager 208 purges the buffer once the payload has been relayed to the second workspace 204.

Complementary actions may occur for relaying communications from the second workspace 204 to the first workspace 204. When the data path manager 208 receives communications from the second workspace 204 at step 614, it unpacks the payload from its initial formatting (e.g., in this case network-based formatting), and stores the payload in a buffer. Moreover at step 616, the data path manager 208 repacks the payload into type-A formatting (e.g., memory-mapped formatting) and sends it to the first workspace 204. At step 618, the data path manager 208 purges the buffer once the payload has been relayed to the first workspace 204.

The previously described process is repeatedly performed as described above for continually processing communications between the first workspace and the second workspace for providing communications between the two. Nevertheless, when use of the method 600 is no longer needed or desired, the method ends. Thus as can be easily seen, the two different data paths may be used to relay communications between one another even though no common data path exists.

FIG. 7 illustrates an example method 700 that may be performed to establish a bridged connection between two workspaces in which the bridged connection is monitored by a third workspace 204 according to one embodiment of the present disclosure. The method 700 generally involves a data path manager 208 that manages bridged data paths to a first workspace 204 and a second workspace 204. The method 700 also involves a third workspace 204 that functions as a transparent workspace for, among other things, providing an access point for monitoring the bridged data path while it is in use, debugging purposes, and/or profiling purposes. In a particular example, the first workspace 204 may be hosting a pulse-audio (e.g., Mic input audio stream) provider, which is linked with a second workspace 204 hosting a Zoom.exe consumer application. Additionally, the third workspace 204, which is attested and authorized, is hosting a ‘Speech-to-Text’ engine that may transparently latch and consume the audio-stream for Speech-to-Text.

At step 702, the method 700 verifies the integrity of the transparent workspace 204. By verifying the integrity, the method 700 may ensure that no hidden files exist within the transparent workspace 204, and that all settings are set to their default values. Thereafter at step 704, the method 700 sets up a data path 706 between the transparent workspace 204 and the data path manager 208. Communication traffic through the data path 706 may be based on whether the communication originated from the provider workspace 204 or the consumer workspace 204. For example, the method 700 may be setup to replicate only the provider's data through the data path 706, and snoop (e.g., replicate both provider and consumer's transactions) through the data path 706.

Thereafter at step 708, the method 700 sets up independent data paths with both of the first and second workspaces 204. For example, the method 700 sets up a first data path 710 with the first workspace 204, and then sets up a second data path 712 with the second workspace 204.

At this point, whenever the first workspace 204 targets a message to the second workspace 204 at step 714, the data path manager 208 conveys the message on to the second workspace 204 in the normal manner at step 716. Additionally, the data path manager 208 replicates the message so that it can be forwarded to the transparent workspace 204 where the message is logged at step 718. Conversely, when a second message is sent from the second workspace 204 to the first workspace 204 at step 720, the data path manager 208 forwards the second message in the normal manner at step 722. Additionally, the data path manager 208 will handle the forwarded second message based upon its current operating mode. If the mode is set to ‘replicate’, the data path manager 208 will do nothing with the second message because it originated from the second workspace 204. If, however, the mode was set to ‘snoop’ mode, the data path manager 208 will replicate the second message originating from the second workspace 204 and send to the transparent workspace 204 in which it is logged for future reference at step 724. In one embodiment, the data path manager 208 may access the data replication driver 210 to snoop the audio content in the second workspace 204, and store its recorded contents in the transparent workspace 204.

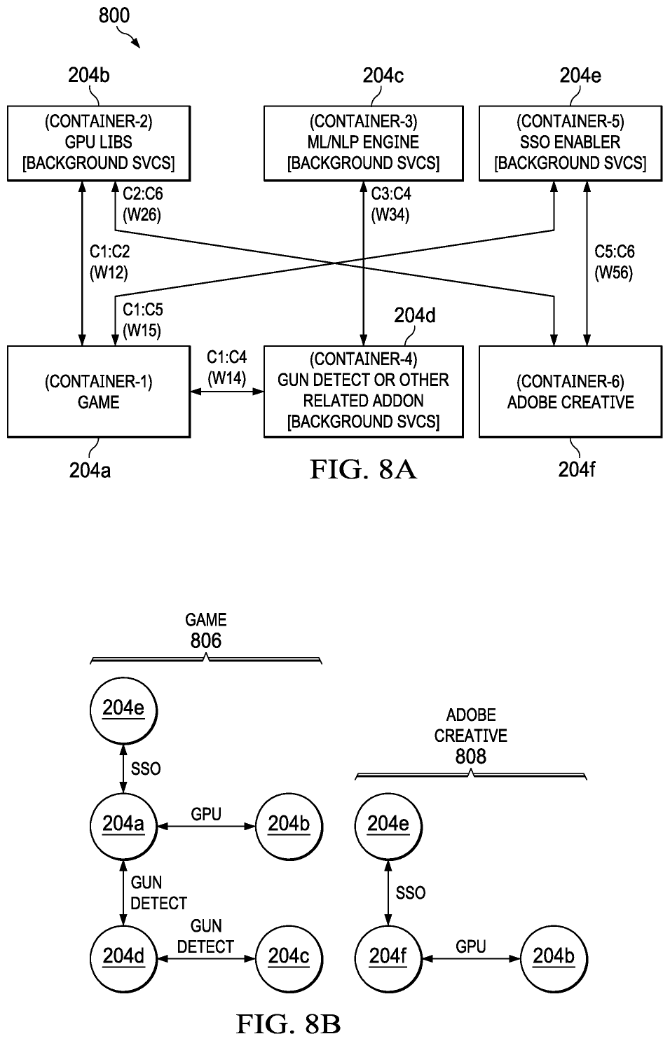

FIGS. 8A and 8B illustrate an example workspace structure 800, and graphs 806, 808 of two example consumer apps that may be implemented by the data path management system 200 according to one embodiment of the present disclosure. In general, FIGS. 8A and 8B illustrate how two example applications, namely a game and an Adobe Creative application, which have been implemented in a heterogeneous workspace environment, may have their cross data paths monitored and optimized as they are used.

Referring now to FIG. 8A, workspace 204a is configured with a game that uses single sign on (SSO) services provided by workspace 204e, GPU services provided by workspace 204b, and gun detection services provided by workspace 204d, which in turn, may have its services rendered by a machine learning (ML) engine configured in workspace 204c. FIG. 8B shows this arrangement in graph form. Referring again to FIG. 8A, workspace 204f is configured with an Adobe Creative application that uses single sign on (SSO) services provided by workspace 204e and GPU services provided by workspace 204b. FIG. 8B shows this arrangement in graph form.

According to embodiments of the present disclosure, weights may be applied to each data path and continually monitored for ongoing changes such that, for example, if operational loading increases on any one data path during its use, the data path manager 208 may migrate the data path to a new, different data path, or even migrate the application and/or one or more of its services so that the operational loading may be alleviated. For example, FIG. 8B depicts a list of the data paths established between the game and the Adobe Creative application and their respective services. Each data path may be assigned with one or more weights based upon various aspects of the connection, such as payload frequency, payload type (e.g., burstiness, continuous, etc.), throughput capacity, loop speed, reliability, and the like. Such weights may be acquired over a period of time by gathering telemetry data, and processing the acquired telemetry data to derive the weighted values that are used.

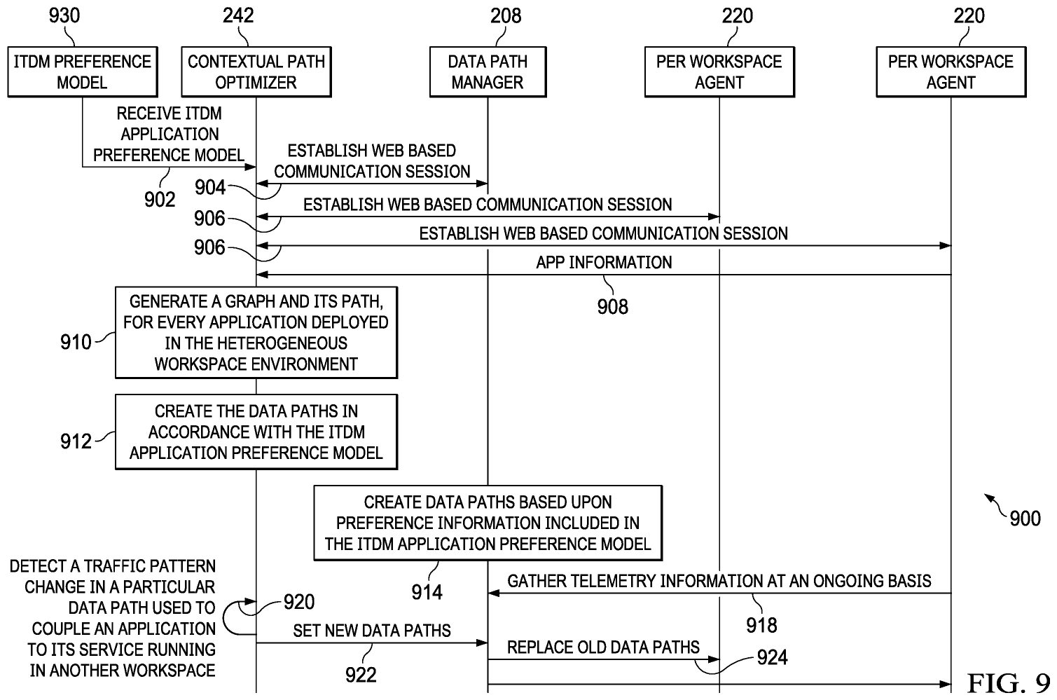

FIG. 9 illustrates an example contextual path optimizing method 900 that may be performed to optimize the data paths of an application and its services implemented in a heterogeneous workspace environment. For example, the application may be one similar to the game or the Adobe Creative application along with their respective services as described above with reference to FIGS. 8A-8B. Initially, the application is instantiated in its workspace 204, and its services are instantiated in separate workspaces 204 of the IHS 100.

At step 902, the contextual path optimizer 242 receives an ITDM application preference model 930. The ITDM preference model 930 generally includes specifications associated with how an application may be implemented in the heterogeneous workspace environment. In response, the contextual path optimizer 242 establishes a Web based communication session with the data path manager 208 at step 904, and Web based communication sessions with the per workspace agents 220 configured on workspaces 204 that are to support the application at step 906. For example, the contextual path optimizer 242 may establish communication sessions with each of the per workspace agents 220 via the web service 218. Once the connection is established, each of the per workspace agents 220 sends its app information, such as a name of the app, hash value of the executable program, certifications, app state, manifest file, and the like at step 908.

At step 910, the contextual path optimizer 242 generates a graph and its path, for every application deployed in the heterogeneous workspace environment based upon its dependencies. Once the graphs have been generated, the contextual path optimizer 242, at step 912, selects the data paths in accordance with the ITDM application preference model 930 received above at step 902. At step 914, the data path manager 208 communicates with the per workspace agents 220 in each workspace 204. In one embodiment, the data path manager 208 creates the data paths based upon preference information included in the ITDM application preference model 930. Nevertheless, if no preference exists for that data path, the data path manager 208 may create a basic, reliable low performing path to be used as a default data path.

At this point, the application along with any data paths to any services in support of the application have been initialized, and is providing a useful workload for the user. During the course of its operation, the data path manager 208 may gather telemetry information at an ongoing basis (e.g., periodically) at step 918. For example, the data path manager 208 may gather traffic parameters, traffic patterns, bandwidth limitations, latency, CPU usage, and the like, which are then sent to the contextual path optimizer 242 for analysis and recommendations.

The contextual path optimizer 242 may also be responsive to changes in traffic patterns for switching from one data path to another data path or even migrating an application and/or its services from one workspace 204 to another. For example, at step 920, the contextual path optimizer 242 may detect a traffic pattern change in a particular data path used to couple an application to its service running in another workspace 204. As such, the contextual path optimizer 242 may use the ITDM application preference model 930 to select another data path, or use a machine learning (ML) process to identify a suitable data path for conveying the traffic between the application and its services.

At step 922, the contextual path optimizer 242 sets a new data path for the application by sending instructions to the data path manager 208. Thereafter at step 924, the data path manager 208 replaces the old data paths created at step 914 with the new data paths as specified by the contextual path optimizer 242. As can be clearly seen from the foregoing, the data paths used to convey traffic between an application and its services configured in other workspaces 204 may be continually optimized for ensuring its performance of operation as the application is used in a heterogeneous workspace environment.

Although FIG. 9 describes an example method 900 that may be performed to optimize data paths of an application deployed in a heterogeneous workspace environment, the features of the method 900 may be embodied in other specific forms without deviating from the spirit and scope of the present disclosure. For example, the method 900 may perform additional, fewer, or different operations than those described in the present example. As another example, certain steps of the aforedescribed method 900 may be performed in a sequence different from that described above. As yet another example, certain steps of the method 900 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a plurality of workspaces that are each deployed with one or more apps; and
instructions stored in at least one memory and executed by at least one processor to:
obtain a plurality of inventories corresponding to the plurality of workspaces, wherein the inventories each include information associated with the applications deployed in its respective workspace;
for each inventory:
identify the workspace associated with the inventory;
determine which of the applications are to be updated with new software; and
deploy the determined new software to the identified workspace.

2. The IHS of claim 1, wherein the instructions are further executed to identify the workspace by extracting at least a portion of the Global Universal Identifier (GUID) from the IHS identifier.

3. The IHS of claim 1, wherein the instructions are further executed to determine which of one or more drivers or firmware are to be updated, and deploy the determined drivers or firmware to the identified workspace.

4. The IHS of claim 1, wherein the IHS comprises a plurality of bare-metal computing devices, wherein the instructions are further executed to obtain the plurality of inventories according to one or more of the workspaces deployed on each of the bare-metal devices.

5. The IHS of claim 1, wherein the instructions are further executed to determine which of the applications are to be updated with new software by identifying a newer version of at least one of the apps.

6. The IHS of claim 1, wherein the instructions are further executed to determine which of the applications are to be updated with new software by identifying a first workspace that has been migrated to a second workspace.

7. The IHS of claim 6, wherein the first workspace comprises at least one of a software-based workspace, a hardware-based workspace, or a cloud-based workspace, and the second workspace comprises a different one of the software-based workspace, the hardware-based workspace, or the cloud-based workspace, and wherein the instructions are further executed to:
migrate the applications from the first workspace to the second workspace; and
purge the inventory associated with the first workspace.

8. The IHS of claim 6, wherein the first workspace is a different type relative to the second workspace, and wherein the instructions are further executed to:
when the application is the same type on the second workspace, move the applications from the first workspace to the second workspace, and purge the inventory associated with the first workspace;
when the application is a different type relative to the application executed on the second workspace, move the application and its dependency information from the first workspace to the second workspace definition in the catalog.

9. The IHS of claim 1, wherein the instructions are further executed to identify the workspace associated with the inventory by:
when the workspace has been determined to be added to the IHS, generate a new inventory for the added workspace; and
when the workspace has been determined to be deleted from the IHS, delete the inventory associated with the deleted workspace.

10. The IHS of claim 1, wherein the instructions are further executed to determine which of the applications are to be updated with new software by:
when one of the applications has been determined to be added to one of the workspaces, add information associated with the application to the inventory associated with the one workspace; and
when one of the applications has been determined to be deleted from the one workspace, delete information associated with the deleted application from the inventory associated with the one workspace.

11. A method comprising:
obtaining, using instructions stored in at least one memory and executed by at least one processor, a plurality of inventories corresponding to a plurality of workspaces that are each deployed with one or more apps, wherein the inventories each include information associated with the applications deployed in its respective workspace;
for each inventory:
identifying, using the instructions, the workspace associated with the inventory;
determining, using the instructions, which of the applications are to be updated with new software; and
deploying, using the instructions, the determined new software to the identified workspace.

12. The method of claim 11, further comprising identifying the workspace by extracting at least a portion of the Global Universal Identifier (GUID) from the IHS identifier.

13. The method of claim 11, further comprising determining which of one or more drivers or firmware are to be updated, and deploy the determined drivers or firmware to the identified workspace.

14. The method of claim 11, wherein the IHS comprises a plurality of bare-metal computing devices, wherein the instructions are further executed to obtain the plurality of inventories according to one or more of the workspaces deployed on each of the bare-metal devices.

15. The method of claim 11, further comprising determining which of the applications are to be updated with new software by identifying a first workspace that has been migrated to a second workspace.

16. The method of claim 15, further comprising migrating the applications from a first workspace to a second workspace, and purging the inventory associated with the first workspace, wherein the first workspace comprises at least one of a software-based workspace, a hardware-based workspace, or a cloud-based workspace, and the second workspace comprises a different one of the software-based workspace, the hardware-based workspace, or the cloud-based workspace.

17. The method of claim 15, further comprising when the application is a same type on the second workspace, migrate the applications from the first workspace to the second workspace, and purge the inventory associated with the first workspace, and when the application is a different type relative to the application executed on the second workspace, move the application and its dependency information from the first workspace to the second workspace definition in the catalog.

18. The method of claim 11, further comprising identifying the workspace associated with the inventory by:
when the workspace has been determined to be added to the IHS, generating a new inventory for the added workspace; and
when the workspace has been determined to be deleted from the IHS, deleting the inventory associated with the deleted workspace.

19. The method of claim 11, further comprising determining which of the applications are to be updated with new software by:
when one of the applications has been determined to be added to one of the workspaces, adding information associated with the application to the inventory associated with the one workspace; and
when one of the applications has been determined to be deleted from the one workspace, deleting information associated with the deleted application from the inventory associated with the one workspace.

20. A workspace orchestrator comprising:
instructions stored in at least one memory and executed by at least one processor to:
obtain a plurality of inventories corresponding to a plurality of workspaces that are each deployed with one or more apps, wherein the inventories each include information associated with the applications deployed in its respective workspace;
for each inventory:
identify the workspace associated with the inventory;
determine which of the applications are to be updated with new software; and
deploy the determined new software to the identified workspace.
